(19) United States
(12) Patent Application Publication
(10) Pub. No.: US 2009/0033088 A1
(43) Pub. Date: Feb. 5, 2009

(54) ROTOMOLD BEAD

(75) Inventor: Giancarlo Battaglini, Gainesville, GA (US)

Correspondence Address: RADER, FISHMAN & GRAUER PLLC, 39533 WOODWARD AVENUE, SUITE 140, BLOOMFIELD HILLS, MI, 48304-0610, US

(73) Assignee: Eaton Corporation, Cleveland, OH (US)

(21) Appl. No.: 11/831,438

(22) Filed: Jul. 31, 2007

(51) Int. Cl. F16L 3/10

(52) U.S. Cl. 285/139.2

(57) ABSTRACT

A method of assembling a fluid-tight coupling, including a sleeve and a first member is provided. The sleeve includes an end portion generally defined by an axis, and the first member includes a bead. A generally axial force is applied to at least one of the sleeve and the first member, urging a collar of the end portion of the sleeve to guide along a first surface portion. The sleeve is moved in a first direction such that at least a portion of the collar moves beyond at least a portion of the bead such that at least a mating surface of the collar is resiliently urged towards the axis and interferes with a sealing surface of the bead. The sealing surface of the bead is generally annular and is defined by a non-arcuate surface that is generally equal to or less than 90° with respect to the axis.

### BACKGROUND INFORMATION

The present disclosure relates to a method of assembling a fluid-tight coupling.

### BRIEF SUMMARY OF THE INVENTION

Typically, a bead is used to seal a connection between a pipe or tubular member and a hose in low-pressure applications, or a sleeve in a fluid-tight or a high pressure application. In high pressure applications, such as aerospace components, the bead is secured by abutting a surface of the bead along a collar of the sleeve. The collar is used to retain the tubular member inside the sleeve by engaging with an outer surface of the bead. The sleeve may be used in conjunction with a channel band coupling to further secure the connection in place. The abutting surfaces of the bead and the collar secure the connection in place, and prevent the connection from separating when an axial force is applied. In low pressure applications, a hose clamp is used to secure a hose over a pipe or a tubular member.

The bead usually includes a generally semi-circular profile. In one example, SAE (Society of Automotive Engineers) Standard AS5131 requires a semi-circular bead for aerospace applications. The semi-circular profile and the collar of the sleeve are in contact with each other at tangential surfaces located along an upper surface and a side surface of the bead. More specifically, the tangential surfaces are located along the apex point of the bead and along the side of the bead that is closest to the collar. The tangential surfaces are the contact points between the bead and the collar that retain the bead in place when an axial force is applied. That is, when a limited axial force is applied to either the sleeve or the tubular member, the bead retains the connection in place and prevents the connection from separation. However, in some high pressure applications, the seal between the bead and the collar may not retain the connection in place when an increased axial force is exerted upon the connection.

Thus, there exists a need for a bead that provides improved sealing in high pressure or fluid-tight applications when compared to a bead with a semi-circular profile.

### BRIEF DESCRIPTION OF THE DRAWINGS

FIG. 1 is an exploded, perspective view of a channel band assembly including a first tubular member, a second tubular member, a channel band and a sleeve;

FIG. 1A is an alternative illustration of the enlarged partial cross section of Region 1A in FIG. 1;

FIG. 2 is the channel band assembly of FIG. 1 with the channel band and the sleeve assembled to both the first tubular member and the second tubular member;

FIG. 3 is an enlarged partial cross section of a portion of the first tubular member and a portion of the sleeve before assembly;

FIG. 3A is an enlarged partial cross section of the first tubular member of FIG. 3;

FIG. 4 is an enlarged partial cross section of a portion of the first tubular member and a portion of the sleeve as a collar of the sleeve is urged along a portion of a bead located along the first tubular member;

FIG. 5 is an enlarged partial cross section of a portion of the second tubular member and a portion of the sleeve as the collar of the second tubular member is urged along a portion of the bead located along the second tubular member;

FIG. 6 is an enlarged partial cross section of a portion of the first tubular member and a portion of the sleeve as a portion of the collar is urged over the bead; and

FIG. 7 is an enlarged partial cross section of a portion of the first tubular member and a portion of the sleeve in final assembly with the collar in interference with a sealing surface of the bead.

### DETAILED DESCRIPTION

Referring now to the discussion that follows and also to the drawings, illustrative approaches to the disclosed systems and methods are shown in detail. Although the drawings represent some possible approaches, the drawings are not necessarily to scale and certain features may be exaggerated, removed, or partially sectioned to better illustrate and explain the present invention. Further, the descriptions set forth herein are not intended to be exhaustive or otherwise limit or restrict the claims to the precise forms and configurations shown in the drawings and disclosed in the following detailed description.

Moreover, there are a number of constants introduced in the discussion that follows. In some cases illustrative values of the constants are provided. In other cases, no specific values are given. The values of the constants will depend on characteristics of the associated hardware and the interrelationship of such characteristics with one another as well as environmental conditions and the operational conditions associated with the disclosed system.

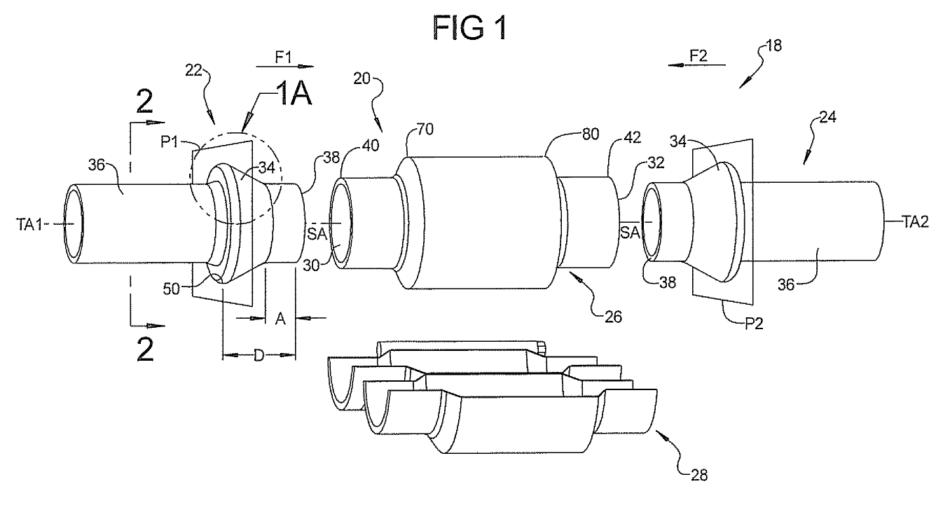

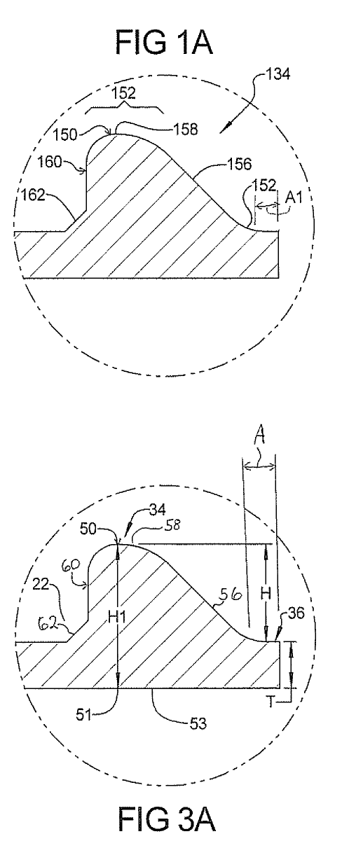

Turning now to the drawings and in particular to FIG. 1, an exemplary tubular connection 18 including a channel band coupling assembly 20, a first tubular member 22 and a second tubular member 24 is disclosed. The channel band coupling assembly 20 includes a sleeve 26 and a channel band coupling 28. In the illustration of FIG. 2, a portion of the first tubular member 22 is received by the sleeve 26 at a first sleeve opening 30, and a portion of the second tubular member 24 is received by the sleeve 26 at a second sleeve opening 32. The first sleeve opening 30 is located along a first end 40 of the sleeve 26 and the second sleeve opening 32 is located along a second end 42 of the sleeve 26.

As illustrated in FIG. 1, both of the first tubular member 22 and the second tubular member 24 include a bead 34 that is located along an outer surface 36 of the tubular members 22 and 24. As seen in FIG. 1, the apex 50 of the bead 34 is located along the circumference of the bead 34 at the outer surface 36.

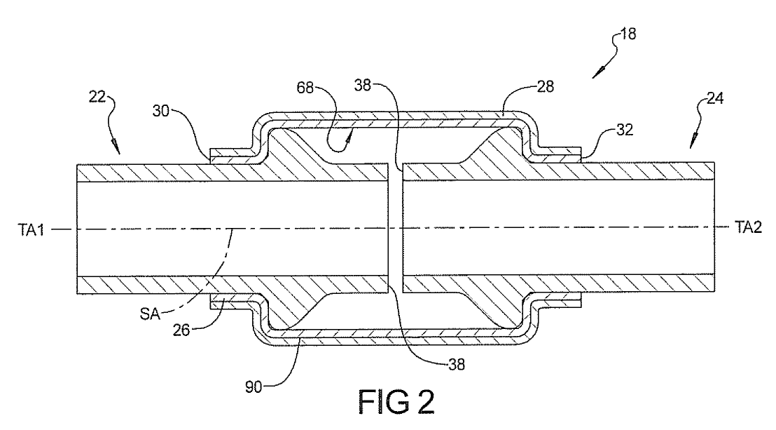

FIG. 1 illustrates the bead 34 being substantially continuous along the entire circumference of the outer surface 36 to facilitate a fluid-tight seal, with the bead 34 including the apex 50 and a profile surface 52. As best seen in FIG. 3A, the profile surface 52 includes first radius 54, a ramp 56, a second radius 58 at apex 50, a sealing surface 60 and chamfer 62.

The bead 34 is adjacent to an end portion 38. More specifically, the apex 50 of the bead 34 is located at a predetermined distance D from the end portion 38, and in one embodiment the distance D is about twenty-five hundredths of an inch (0.25 in or 6.35 mm). Moreover, a second dimension A is measured between the first radius 54 of the bead 34 and the end portion 38. In one alternative illustration, as seen in FIG. 1A, the distance A1 (shown for illustrative purposes only) is zero inches (0.00 in or 0.00 mm). However, the dimension A may range from about zero inches (0.00 in or 0.00 mm) to about five tenths inch (0.5 in or 12.7 mm) and beyond.

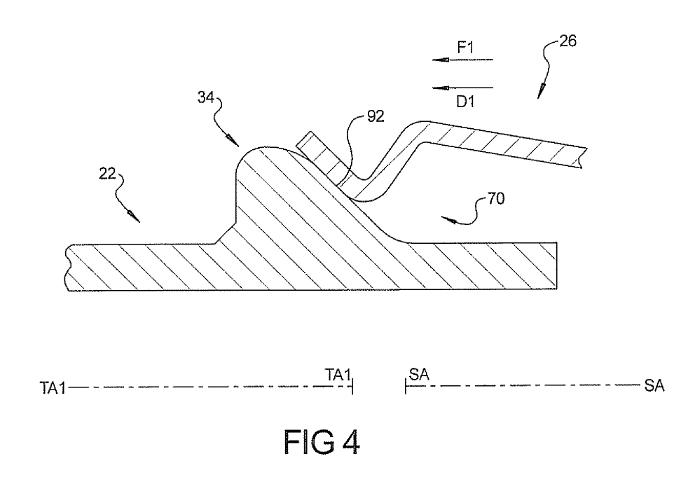

As illustrated in FIGS. 1 and 3, the sleeve 26 includes an inner surface 68 and a first collar 70 and a second collar 80, where the first collar 70 is located adjacent the first sleeve opening 30 and the second collar 80 is located adjacent the second sleeve opening 32. As illustrated in FIG. 3, the first collar 70 includes a mating surface 78, a first end 74 and a second end 76. The first end is connected to the inner surface 68 and the second end 76 is located radially inwardly from the first end 74 towards an axis SA of the sleeve. As illustrated in FIG. 5, the second collar 80 also includes a mating surface 88, first end 84 and a second end 86. It should be noted that while FIGS. 1-7 illustrate a sleeve 26 including two openings 30 and 32 receiving both of the tubular members 22 and 24, it is understood that a hose or a sleeve having only one opening for receiving only one of the tubular members 22, 24 may be used. That is, for example, a sleeve, such as the sleeve 26, may include the first sleeve opening 30 and first collar 70 for receiving the first tubular member 22 at a first end, such as the first end 40, and any other connector at the other end of the sleeve. Although FIG. 1 illustrates the tubular connection 18 to include a channel band coupling 28, the bead 34 of either the first tubular member 22 or the second tubular member 24 may be utilized to seal a hose or sleeve 26 with the aid of a conventional hose clamp (not shown) as well.

In the illustration as shown, the channel band coupling assembly 20 and the tubular members 22 and 24 are part of an air duct assembly for transferring air to the pressurized interior of an aircraft. It should be noted that while FIG. 1 illustrates the tubular connection 18 as an air duct assembly for an aircraft, the connection may be utilized in any application for fluid-tight or high pressure sealing such as, but not limited to, a radiator hose for an automobile. Moreover, the tubular connection 18 may also be used in a low pressure application where a flow tight seal is not critical.

In the illustrations as shown in FIGS. 1 and 2, the first tubular member 22 includes a first tubular axis TA1, the second tubular member 24 includes a second tubular axis TA2, and the sleeve 26 includes the sleeve axis SA. The end portion 38 of the first tubular member 22 is generally defined by the first tubular axis TA1, and the end portion 38 of the second tubular member 24 is generally defined by the second tubular axis TA2. When the first tubular member 22 is received by the sleeve 26 at the first sleeve opening 30, the first tubular axis TA1 is generally aligned with the sleeve axis SA. Moreover, when the second tubular member 24 is received by the sleeve 26 the second tubular axis TA2 is generally aligned with the sleeve axis SA as well. Indeed, as best seen in FIG. 2 when the channel band coupling assembly 20 is assembled, each of the first tubular axis TA1, the second tubular axis TA2 and the sleeve axis SA are all generally aligned with one another.

FIG. 2 is a partial cross section of the tubular connection 18 assembled. The first tubular member 22 is selectively received by the sleeve 26 at the first sleeve opening 30, and the second tubular opening 24 is selectively received by the sleeve 26 at the second sleeve opening 32. The channel band coupling 28 may then be clamped along at least a portion of a circumference of the sleeve 26. As seen in FIG. 2, the channel band coupling 28 is clamped along the sleeve 26 by any fastening mechanisms, such as, but not limited to, a nut and bolt assembly, a latch or a crimped strap. The channel band coupling 28 further retains the tubular connection 18 in place. The channel band coupling 28 is constructed from materials such as, but not limited to, steel.

The tubular connection 18 is assembled such that the end portion 38 of the first tubular member 22 does not contact the end portion 38 of the second tubular member 24 in the illustration as shown in FIG. 2. Thus, the sleeve 26 acts as a vibration damper or isolator. That is, when the first tubular member 22 experiences a deflection due to vibration, the deflection is transferred to the sleeve 26. Because the sleeve 26 is generally constructed from a flexible material, as discussed in greater detail below, the sleeve 26 acts as a vibration damper. Thus, the deflection or vibration experienced by the first tubular member 22 is damped by the sleeve 26 such that only a portion of the deflection, or none of the deflection is transferred to the second tubular member 24.

FIG. 3 is an enlarged partial cross section of a portion of the first tubular member 22 and a portion of the sleeve 26 in FIG. 1. The first end 40 of the sleeve 26 is generally defined by the axis SA. The ramp 56 of the bead 34 is located adjacent to the end portion 38. The apex point 50 is positioned between the sealing surface 60 and the ramp 56. The sealing surface 60 of the bead 34 is generally annular, and is a non-arcuate surface that is generally equal to or less than 90° with respect to the first tubular axis TA1.

In one illustration as shown in FIGS. 3-7, a first plane P1 that is generally perpendicular to the first tubular axis TA1 generally defines the sealing surface 60 along the first tubular member 22. Thus, the sealing surface 60 is generally perpendicular to at least a portion of the outer surface 36 the first tubular member 22. Additionally, as best seen in FIG. 5, a second plane P2 that is generally perpendicular to the second tubular axis TA2 defines the sealing surface 60 along the second tubular member 24 as well. However, it is understood that both of the planes P1 and P2 may not be generally perpendicular to the tubular axis TA1 and TA2 as well.

In one illustration as seen in FIG. 3A, the height H of the bead 34 is about equal to the wall thickness T of the first tubular member 22 when the bead 34 is measured from the apex 50 to the outer surface 36 of the first tubular member 22. That is, the ratio of height H of the bead 34 and the wall thickness T is about 9:10. In the embodiment as illustrated in FIG. 3A, the bead 34 is solid. More specifically, a distance H1 is measured between the apex 50 of the bead 34 and a point 51 located on an inner surface 53 of the first tubular member 22. The point 51 generally opposes the apex 50 of the bead 34. The distance H1 is about equal to the height H of the bead 34 plus the wall thickness T of the first tubular member 22 combined.

FIG. 3 illustrates the ramp 56 inclined away from the axis TA1 from a first ramp end 64 to a second ramp end 66. The first ramp end 64 is positioned adjacent to the end portion 38, and the second ramp end 66 is positioned adjacent to the second radius 58. The ramp 56 is oriented such that the first ramp end 64 is farther from the first tubular axis TA1 than the second ramp end 66. That is, the ramp 56 is inclined upwardly between the end portion 38 and the apex point 50 of the bead.

The frusto-conical surface of the ramp 56 may allow for ease of insertion during assembly of the first tubular member 22 with the sleeve 26, which is discussed in greater detail below. More specifically, the ramp 56 may require less force for insertion into the sleeve 26 when compared to a traditional bead with a semi-circular profile. In the embodiment as illustrated, the ramp 56 is inclined at an angle α measured along the profile surface 52 of the ramp 56 relative to the outer surface 36 adjacent the end portion 38. In one example, the bead 34 is between about one-hundred-twenty-five degrees (125°) to about one-hundred-forty-five degrees (145°) when utilized for the SAE Standard AS5131. However, it should be noted that while FIG. 3 illustrates the angle α between about one-hundred-twenty-five degrees (125°) to about one-hundred-forty-five degrees (145°), other angles may be used as well.

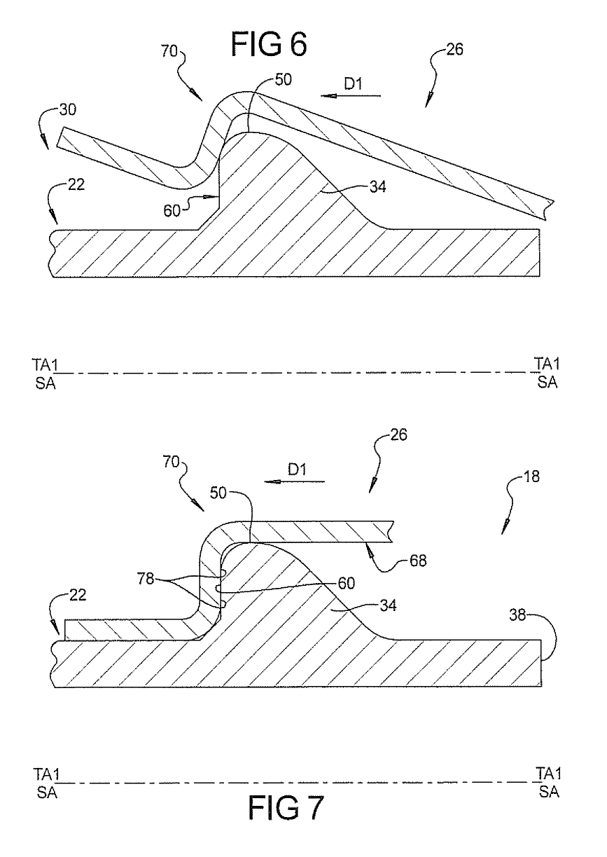

When the mating surface 78 interferes with the sealing surface 60 of the bead 34 along the first tubular member 22, as best seen in FIG. 7, a seal is formed. Moreover, as best seen in FIG. 2, the apex 50 of the bead 34 is also a sealing surface, because the apex 50 contacts the inner surface 68 of the sleeve 26. The seal may be generally fluid-tight in some applications. That is, the seal does not allow for appreciable amounts of gas or liquid to flow between the sealing surface 60 and the mating surface 78 or the apex 50 of the bead and the inner surface 68 of the sleeve 26. Moreover, the interference of the mating surface 78 and the sealing surface 60 restricts movement of the first collar 70 when the first collar 70 is urged in a direction towards the end portion 38. As best seen in FIG. 7, the apex 50 of the bead 34 also seals along the inner surface 68 of the sleeve 26. Indeed, the bead 34 may be particularly advantageous to use in high-pressure applications due to the sealing surface 60 and the apex 50.

This is because the sealing surface 60 provides an increased amount of surface area contact with the first collar 70 when compared to a traditional bead that includes a generally semi-circular profile. In addition, as best seen in FIG. 3, prior to assembly of the channel band coupling assembly 20, the first collar 70 is in a relaxed state. That is, the mating surface 78 of the first collar 90 is at a collar angle α2 that is equal to or less than 90° with respect to the sleeve axis SA. When the collar angle α2 is less than 90°, a springing effect that promotes assembly is created. More specifically, the collar angle α2 is slightly less than a sealing surface angle α3 of the first plane P1. Thus, during assembly the mating surface 78 is urged up against the sealing surface 60 of the bead 34, in the opposite direction of the inner surface 68 of the sleeve 26. This is because the collar angle α2 is less than the sealing surface angle α3, thereby providing a generally fluid-tight seal therebetween.

The mating surfaces 78 and 88 of the collars 70 and 80 both restrict the movement of the first tubular member 22 and the second tubular member 24 during dynamic loading caused by, for example, fluid or gas flow. In one example, when the tubular members 22 and 24 include a diameter of four inches (4.00 in or 101.6 mm), the channel band assembly coupling 18 may withstand a pressure up to about ninety pounds per square inch (90 psi or 620.52 kPa). That is, the mating surfaces 78 and 88 of the collars 70 and 80 between the sealing surfaces 60 of the bead 34 prevent the flow of gas or fluid from escaping the interior of the tubular connection 18. In the embodiment as illustrated, and especially in fluid-tight applications, both of the collars 70 and 80 are substantially continuous at the mating surfaces 78 and 88 along the entire circumference of the inner surface 68 of the sleeve 26. Although FIG. 3 illustrates the mating surface 78 of the first collar 70 orientated at a collar angle α2 relative to the axis SA, the mating surface 78 of the first collar 70 may also be generally parallel with the sealing surface 60 of the bead 34 of the first tubular member 22. The angle α2 may be 90 degrees or other suitable angles, such as more than 90 degrees, that permit the pressure of fluid flow within the connection 18 to deflect the sleeve 26 to deflect while maintaining the integrity of the connection 18. It should be noted that while FIG. 7 illustrates a seal located between the first collar 70 and the bead 34 of the first tubular member 22, a seal may also be formed between the second collar 80 and the bead 34 of the second tubular member 24.

Once both of the first tubular member 22 and the second tubular member 24 have been received by the sleeve 26, the channel band coupling 28 may then be clamped along at least a portion of the circumference of the sleeve 26, as seen in FIG. 2. The sleeve 26 is typically constructed from flexible materials that allow for the collars 70 and 80 to deform during assembly such as, but not limited to, rubber or a fiberglass impregnated rubber. More specifically, the fiberglass impregnated rubber will include a layer of fiberglass with a layer of rubber along the inner surface 68 and a layer of rubber along an outer surface 90 of the sleeve 26. The collars 70 and 80 are able to selectively flex away from the sleeve axis SA during assembly as the collars 70 and 80 advance along the ramp 56 because the sleeve 26 is typically constructed from flexible materials such as rubber, but are biased to return to the relaxed orientation as seen in FIG. 3.

The first tubular member 22 and the second tubular member 24 are usually constructed from materials such as, but not limited to, linear low density polyethylene (LLDPE), high density polyethylene (HDPE), nylon, polypropylene, aluminum, steel or titanium. The tubular members 22 and 24 are typically injection molded or rotomolded when constructed from a polymer. The bead 34 may be formed on the outer surface 36 using different approaches. For example, the bead 34 may be molded on the tubular members 22 or 24 during the molding process. Alternatively, the bead 34 may be machined on the outer surface 36.

An exemplary method of assembling the tubular connection 18 will now be explained in detail. FIG. 3 illustrates the end portion 38 of the first tubular member 22 interposed with the first end 40 of the first sleeve opening 30. The end portion 38 of the first tubular member 22 is arranged with the first end 40 of the sleeve such that each of the ends 30 and 40 are generally aligned.

Although FIGS. 3-4 and 6-7 illustrate only the first tubular member 22 being assembled to the sleeve 26, the same method may also be applied to assemble the second tubular member 24 to the sleeve 26 as well. That is, the same method used to assemble the end portion 38 of the first tubular member 22 to the sleeve 26 may also be used to assemble the end portion 38 of the second tubular member 24 to the second sleeve opening 32.

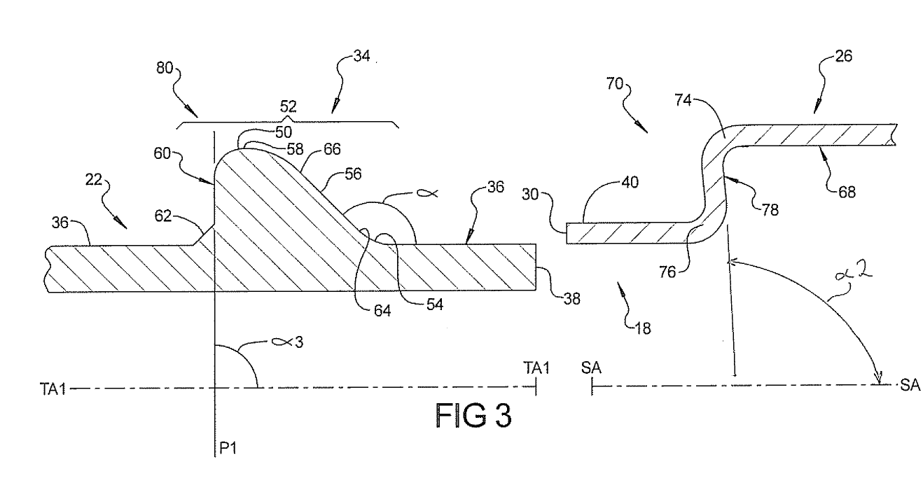

FIG. 4 illustrates a generally axial first force F1 selectively applied to the sleeve 26. The axial first force F1 urges at least a portion of the first collar 70 located adjacent the first sleeve opening 30 along a first surface portion 92 of the bead 34. The axial first force F1 urges at least a portion of the first collar 70 located adjacent the first sleeve opening 30 away from the sleeve axis SA as the sleeve 26 moves generally in a first direction D1 relative to the first tubular member 22. It should be noted that while FIG. 4 illustrates the axial first force F1 being applied to the sleeve 26, the axial first force F1 may also be applied to the first tubular member 22 as well.

A generally axial second force F2 may also be selectively applied to the sleeve 26, as seen in FIG. 5. The axial second force F2 urges the second collar 80 located adjacent the second sleeve opening 32 along the first surface portion 92 of the bead 34 that is usually located along the second tubular member 24 in the same manner as the first axial force F1. The axial second force F2 also urges at least a portion of the second collar 80 located adjacent the second sleeve opening 32 away from the sleeve axis SA as the sleeve 26 moves generally in a second direction D2 relative to the second tubular member 24. As discussed above, it should be noted that while FIG. 5 illustrates the axial second force F2 being applied to the sleeve 26, the axial second force F2 may also be applied to the second tubular member 24 as well.

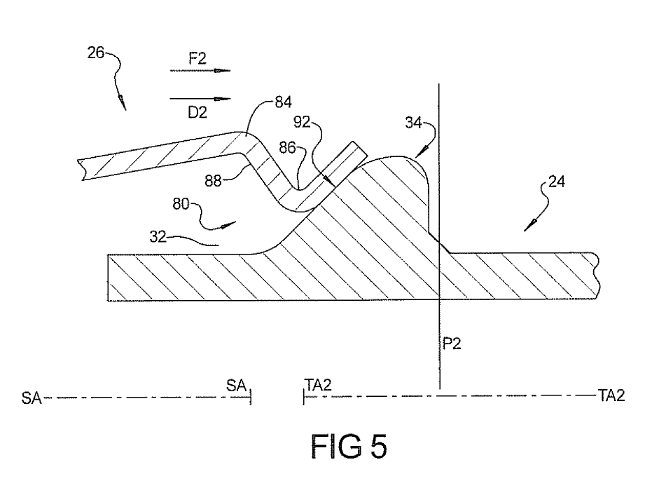

FIG. 6 illustrates the sleeve 26 being moved in the first direction D1 such that at least a portion of the first collar 70 located adjacent the first sleeve opening 30 moves beyond at least a portion of the bead 34. That is, the first collar 70 may be moved in the first direction D1 past the apex point 50 of the bead 34 of the first tubular member 22. Then, as seen in FIG. 7, at least the mating surface 78 of the first collar 70 may then be resiliently urged towards the sleeve axis SA such that the mating surface 78 of the first collar 70 interferes with the sealing surface 60 of the bead 34. The sleeve axis SA is aligned with the first tubular member axis TA1. When the mating surface 78 interferes with the sealing surface 60, the interference will selectively restrict movement of the first tubular member 22 in the direction D1 relative to the sleeve 26. Moreover, the interference between the mating surface 78 and the sealing surface 60 and the apex 50 of the bead 34 and the inner surface 68 of the sleeve each typically allow for a fluid-tight seal.

The present disclosure has been particularly shown and described with reference to the foregoing embodiments, which are merely illustrative of the best modes for carrying out the disclosure. It should be understood by those skilled in the art that various alternatives to the embodiments of the disclosure described herein may be employed in practicing the disclosure without departing from the spirit and scope of the disclosure as defined in the following claims. It is intended that the following claims define the scope of the disclosure and that the method and apparatus within the scope of these claims and their equivalents be covered thereby. This description of the disclosure should be understood to include all novel and non-obvious combinations of elements described herein, and claims may be presented in this or a later application to any novel and non-obvious combination of these elements. Moreover, the foregoing embodiments are illustrative, and no single feature or element is essential to all possible combinations that may be claimed in this or a later application.

I claim:

1. A method of assembling a fluid-tight coupling, comprising the steps of:
interposing an end portion of a first member within an end portion of a sleeve where the first member includes a bead and the end portion of the sleeve is generally defined by an axis;
applying a generally axial force to at least one of the sleeve and the first member and urging at least a portion of a collar of the of the end portion of the sleeve to guide along a first surface portion of the bead and urging at least a portion of the collar away from the axis as the sleeve moves generally in a first direction relative to the first member; and
moving the sleeve in the first direction, at least a portion of the collar moving beyond at least a portion of the bead such that at least a mating surface of the collar is resiliently urged toward the axis and at least the mating surface of the collar interferes with a sealing surface of the bead to restrict movement of the first member in the first direction relative to the sleeve;
wherein the sealing surface of the bead is generally annular and defined by a non-arcuate surface that is generally equal to or less than 90° with respect to the axis;
wherein the bead includes a profile surface located along the bead viewed parallel to the axis, the profile surface including a ramp, an apex and the sealing surface, where the ramp is positioned adjacent to the end portion, and the apex is positioned between the sealing surface and the ramp;
wherein the bead is substantially continuous along an entire circumference of an outer surface of the first member.

2. The method of claim 1, further comprising clamping a secondary member along at least a portion of a circumference of the sleeve, for further restricting movement between the sleeve and the first member.

3. The method of claim 2, wherein said secondary member is one of a channel band coupling and a hose clamp.

4. The method of claim 1, further comprising interposing an end portion of a second member within a second end portion of the sleeve, where the second member includes a second bead.

5. The method of claim 4, further comprising applying a second generally axial force to at least one of the second member and the sleeve urging at least a portion of a second collar of the second end portion of the sleeve to guide along a surface portion of the second bead, and urging at least a portion of the second collar away from the axis as the sleeve moves generally in a second direction relative to the second member.

6. The method of claim 5, further comprising moving the sleeve relative to the second member in the second direction, at least a portion of the second collar moving beyond at least a portion of the second bead such that at least a mating surface of the second collar is resiliently urged toward the axis.

7. The method of claim 6, further comprising engaging a portion of the second collar with a second sealing surface of the second bead.

8. The method of claim 7, wherein the end portion of the first member is spaced away from the end portion of the second member.

9. The method of claim 1, wherein the mating surface of the collar that interferes with the sealing surface of the bead is generally parallel with the sealing surface of the bead to provide a generally fluid-tight seal therebetween.

10. The method of claim 1, wherein the collar at the mating surface is substantially continuous along the entire circumference of the sleeve.

11. The method of claim 1, wherein a height of the bead is about equal to a wall thickness of the first member when the bead is measured from the apex of the bead to the outer surface of the first member.

12. The method of claim 11, wherein the distance between the apex of the bead and a point located on an inner surface of the first member that generally opposes the apex of the bead is about equal to the combined height of the bead and the wall thickness.

13. A method of assembling a fluid-tight coupling, comprising the steps of:
interposing an end portion of a first member within a first end of a sleeve, where the first member includes a first bead and the sleeve is generally defined by an axis;
interposing an end portion of a second member within a second end portion of the sleeve, where the second member includes a second bead;
applying a first generally axial force to at least one of the first member and the sleeve and urging at least a portion of a first collar of the first end portion of the sleeve to guide along a surface portion of the first bead and urging at least a portion of the first collar away from the axis as the sleeve moves generally in a first direction towards the first member;
applying a second generally axial force to at least one of the second member and the sleeve and urging at least a portion of a second collar of the second end portion of the sleeve to guide along a surface portion of the second bead and urging at least a portion of the second collar away from the axis as the sleeve moves generally in a second direction relative to the second member;
moving the sleeve in the first direction relative to the first member, at least a portion of the first collar moving beyond at least a portion of the first bead such that at least a mating surface of the first collar is resiliently urged toward the axis;
moving the sleeve in the second direction relative to the second member, at least a portion of the second collar moving beyond at least a portion of the second bead such that at least a mating surface of the second collar is resiliently urged toward the axis; and
engaging the mating surface of the first collar with a first sealing surface of the first bead; and
engaging the mating surface of the second collar with a second sealing surface of the second bead;
wherein engagement of the first collar with the first sealing surface restricts movement of the sleeve in the first direction relative to the first member and engagement of the second collar with the second sealing surface restricts movement of the sleeve in the second direction relative to the second member;
wherein the first sealing surface is generally annular and defined by a first plane that is generally perpendicular to the axis;
wherein the second sealing surface is generally annular and defined by a second plane that is generally perpendicular to the axis;
wherein the first bead is substantially continuous along an entire circumference of a first outer surface of the first member and the second bead is substantially continuous along an entire circumference of a second outer surface of the second member.

14. The method of claim 13, further comprising clamping a secondary member along at least a portion of a circumference of the sleeve, for further restricting movement between the sleeve and at least one of the first member and the second member.

15. The method of claim 14, wherein said secondary member is one of a channel band coupling and a hose clamp.

16. The method of claim 13, wherein the mating surface of the first collar that interferes with the first sealing surface is generally parallel to the first sealing surface and the mating surface of the second collar that interferes with the second sealing surface is generally parallel to the second sealing surface to provide a generally fluid-tight seal therebetween.

17. The method of claim 13, wherein the end portion of the first member is spaced away from the end portion of the second member.

18. The method of claim 13, wherein the first collar at the mating surface is substantially continuous along the entire circumference of the first member and the second collar at the mating surface is substantially continuous along the entire circumference of the second member.

19. A fluid-tight coupling assembly, comprising:
a generally tubular member including an outer surface and an end portion, where the end portion is generally defined by a tubular member axis;
a bead located on the tubular member and positioned along the outer surface adjacent the end portion, the bead being substantially continuous along the entire circumference of the outer surface;
a profile surface located along the bead viewed parallel to the tubular member axis, the profile surface including a ramp, an apex and a sealing surface, where the ramp is positioned adjacent to the end portion and the apex is positioned between the sealing surface and the ramp;
a sleeve including a sleeve end and an inner surface, the sleeve end for receiving at least a portion of the tubular member, where the sleeve end is generally defined by a sleeve axis; and
a collar including a mating surface, a first end and a second end, the collar located along the inner surface of the sleeve adjacent the sleeve end, where the first end is connected to the inner surface of the sleeve and the second end is located radially inwardly from the first end;
wherein the sealing surface of the bead is generally annular and is defined by a non-arcuate surface that is generally equal to or less than 90° with respect to the tubular member axis;
wherein the interference of the mating surface of the collar and the sealing surface restricts movement of the collar when the collar is urged in a direction towards the end portion of the tubular member.

20. The coupling assembly of claim 19, wherein the sealing surface of the bead is generally perpendicular to the tubular member axis.

21. The coupling assembly of claim 19, wherein the mating surface of the collar is less than 90° with respect to the sleeve axis when the collar is in a relaxed state.
